(19) United States
(12) Patent Application Publication
(10) Pub. No.: US 2021/0089571 A1
(43) Pub. Date: Mar. 25, 2021

(54) MACHINE LEARNING IMAGE SEARCH

(71) Applicant: Hewlett-Packard Development Company, L.P., Spring, TX (US)

(72) Inventors: Christian Perone, Porto Alegre (BR); Thomas da Silva Paula, Porto Alegre (BR); Roberto Pereira Silveria, Porto Alegre (BR)

(21) Appl. No.: 16/498,952

(22) PCT Filed: Apr. 10, 2017
(86) PCT No.: PCT/US2017/026829

§ 371 Date: Sep. 27, 2019

(51) Int. Cl. G06F 16/56; G06F 16/583; G06F 40/40; G06F 40/289; G06N 3/08; G06F 16/51

(52) U.S. Cl. CPC G06F 16/56; G06F 16/5846; G06F 16/51; G06F 40/289; G06N 3/08; G06F 40/40

(57) ABSTRACT

A machine learning encoder encodes images into image feature vectors representable in a multimodal space. The encoder also encodes a query into a textual feature vector representable in the multimodal space. The image feature vectors are compared to the textual feature in the multimodal space to identify an image matching the query based on the comparison.

### BACKGROUND

Electronic devices have revolutionized capture and storage of digital images. Many modern electronic devices are equipped with cameras, e.g. mobile phones, tablets, laptops, etc. The electronic devices capture digital images including videos. Some electronic devices capture multiple images of the same scene to capture a better image. Electronic devices capture videos which may be considered as a stream of images. In many instances, electronic devices have large memory capacity, which can store thousands of images. This encourages capture of more images. Also, the cost of these electronic devices has continued to decline. Due to the proliferation of devices and availability of inexpensive memory, digital images are now ubiquitous and personal catalogs may feature thousands of digital images.

### BRIEF DESCRIPTION OF DRAWINGS

Examples are described in detail in the following description with reference to the following figures. In the accompanying figures, like reference numerals indicate similar elements.

FIG. 1 illustrates a machine learning image search system, according to an example;

FIG. 2 illustrates a data flow for the machine learning image search system, according to an example;

FIGS. 3A, 3B and 3C illustrates training flow for the machine learning image search system, according to examples;

FIG. 4 illustrates a printer embedded machine learning image search system, according to an example; and

FIG. 5 illustrates a method, according to an example.

### DETAILED DESCRIPTION OF EMBODIMENTS

For simplicity and illustrative purposes, the principles of the embodiments are described by referring mainly to examples thereof. In the following description, numerous specific details are set forth in order to provide an understanding of the embodiments. It will be apparent, however, to one of ordinary skill in the art, that the embodiments may be practiced without limitation to these specific details. In some instances, well known methods and/or structures have not been described in detail so as not to unnecessarily obscure the embodiments.

According to an example of the present disclosure, a machine learning image search system may include a machine learning encoder that can translate images to image feature vectors. The machine learning encoder may also translate a received query to a textual feature vector to search the image feature vectors to identify an image matching the query.

The query may include a textual query or a natural language query that is converted to a text query through natural language processing. The query may include a sentence or a phrase or a set of words. The query may describe an image for searching.

The feature vectors, which may include image and/or textual feature vectors, may represent properties of a feature an image or properties of a textual description. For example, an image feature vector may represent edges, shapes, regions, etc. A textual feature vector may represent similarity of words, linguistic regularities, contextual information based on trained words, description of shapes, regions, proximity to other vectors, etc.

The feature vectors may be representable in a multimodal space. A multimodal space may include k-dimensional coordinate system. When the image and textual feature vectors are populated in the multimodal space, similar image features and textual features may be identified by comparing the distances of the feature vectors in the multimodal space to identify a matching image to the query.

One example of a distance comparison may include a cosine proximity, where the cosine angles between feature vectors in the multimodal space are compared to determine closest feature vectors. Cosine similar features may be proximate in the multimodal space, and dissimilar feature vectors may be distal. Feature vectors may have k-dimensions, or coordinates in a multimodal space. Feature vectors with similar features are embedded close to each other in the multimodal space in vector models.

In prior search systems, images may be manually tagged with a description, and matches may be found by searching the manually-added descriptions. The tags, including textual descriptions, may be easily decrypted or may be human readable. Thus, prior search systems have security and privacy risks. In an example, of the present disclosure, feature vectors or embeddings may be stored, without storing the original images and/or textual description of images. The feature vectors are not human readable, and thus are more secure. Furthermore, the original images may be stored elsewhere for further security.

Also, in an example of the present disclosure, encryption may be used to secure original images, feature vectors, index, identifier other intermediate data disclosed herein.

In an example of the present disclosure, an index may be created with feature vectors and identifiers of the original images. Feature vectors of a catalog of images may be indexed. A catalog of images may be a set of images wherein the set includes more than one image. An image may be a digital image or an image extracted from a video frame. Indexing may include storing an identifier (ID) of an image and its feature vector, which may include an image and/or text feature vector. Searches may return an identifier of the image. In an example, a value of k may be selected to obtain a k-dimensional image feature vector smaller than the size of at least one image in the catalog of images. Thus, it takes less amount of storage space to store the feature vector compared to the actual image. In an example, feature vectors are less than or equal to 4096 dimensions (e.g., k less than or equal to 4096). Thus, images in very large datasets with millions of images can be converted into feature vectors that take up considerably less space than the actual digital images. Furthermore, the searching of the index takes considerably less time than conventional image searching.

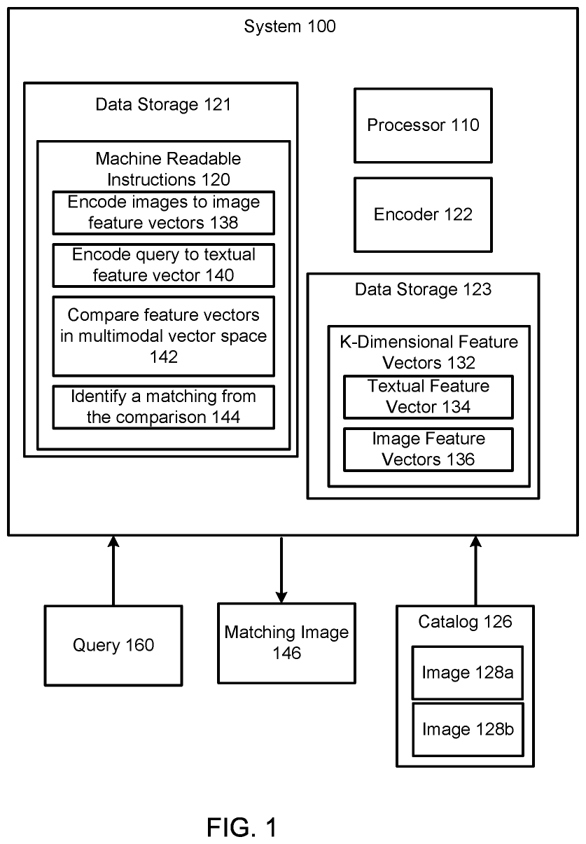

FIG. 1 shows an example of a machine learning image search system 100, referred to as system 100. The system 100 may include a processor 110 and a data storage 121 and a data storage 123. The processor 110 is hardware such as an integrated circuit, e.g., a microprocessor or another type of processing circuit. In other examples, the processor 110 may include an application-specific integrated circuit, field programmable gate arrays or other type of integrated circuits designed to perform specific tasks. The processor 110 may include a single processor or multiple separate processor. The data storage 121 and the data storage 123 may include a single data storage device or multiple data storage devices. The data storage 121 and the data storage 123 may include memory and/or other types of volatile or nonvolatile data storage devices. In an example, the data storage 121 may include a non-transitory computer readable medium storing machine readable instructions 120 that are executable by the processor 110. Examples of the machine readable instructions 120 are shown as 138, 140, 142 and 144 and are further described below. The system 100 may include machine learning encoder 122 which may encode images and text features to generate k-dimensional feature vectors 132, whereby k is an integer greater than 1. In an example, a machine learning encoder 122 may be a Convolutional Neural Network-Long Short Term Memory (CNN-LSTM) encoder. The machine learning encoder 122 performs feature extraction for images and text. As is further discussed below, the k-dimensional feature vectors 132 may be used to identify images matching query 160. The encoder 122 may comprise data and machine readable instructions stored in one or more of the data storages 121 and 123.

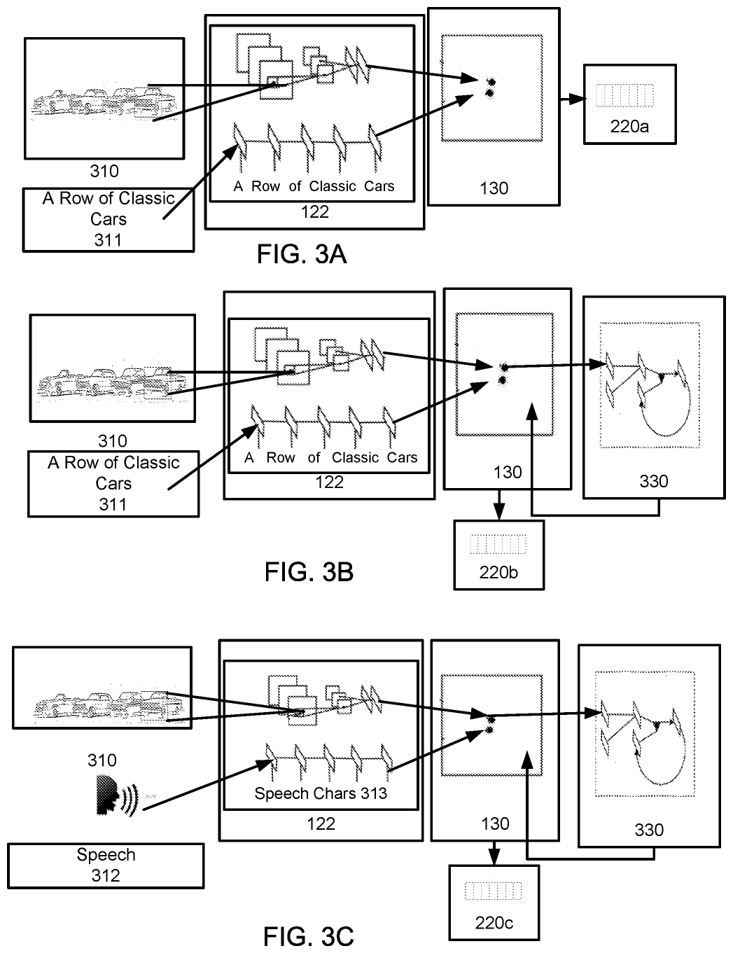

The machine readable instructions 120 may include machine readable instructions 138 to encode images in a catalog 126 using the encoder 122 to generate image feature vectors 136. For example, the system 100 may receive a catalog 126 for encoding. The encoder 122 encodes each image 128a, 128b, etc., in the catalog 126 to generate a k-dimensional image feature vector of each image 128a, 128b, etc. Each of the k-dimensional feature vectors 132 is representable in a multimodal space, such as the multimodal space 130 shown in FIG. 3A, 3B or 3C. In an example, the encoder 122 may encode a k-dimensional image feature vector to represent at least one image feature of each image of the catalog 126. The system 100 may receive the query 160. For example, the query 160 may be a natural language sentence, a set of words, a phrase etc. The query 160 may describe an image to be searched. For example, the query 160 may include characteristics of an image, such as “dog catching a ball”, and the system 100 can identify an image from the catalog 126 matching the characteristics, such as at least one image including a dog catching a ball. The processor 110 may execute the machine readable instructions 140 to encode the query 160 using the encoder 122 to generate the k-dimensional textual feature vector 134 from the query 160.

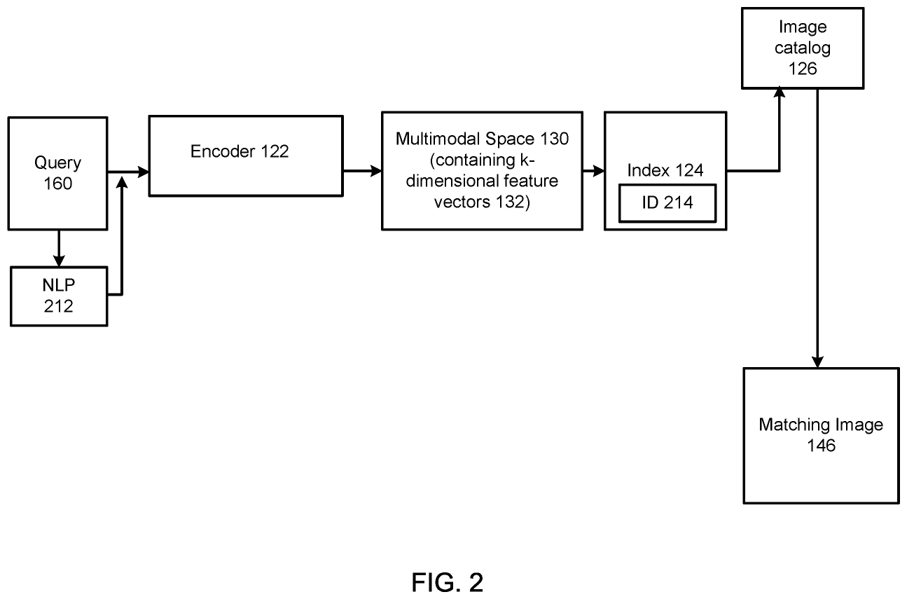

To perform the matching, the processor 110 may execute the machine readable instructions 142 to compare the textual feature vector 134 generated from the query 160 to the image feature vectors 136 generated from the images in the catalog 126. The textual feature vector 134 and the image feature vectors 136 may be compared in the multimodal space 130 to identify a matching image 146, which may include at least one matching image from the catalog 126. For example, the processor 110 executes the machine readable instructions 144 to identify at least one image from the catalog 126 matching the query 160. In an example, the system 100 may identify the top-k images from the catalog 126 matching the query 160. In an example, the system 100 may generate an index 124 shown and described in more detail with reference to FIGS. 2 and 3, for searching the image feature vectors 136 to identify the matching image 146.

In an example, the encoder 122 includes a convolutional neural network (CNN), which is further discussed below with respect to FIGS. 2 and 3. The CNN may be a CNN-LSTM as is discussed below. The images of the catalog 126 may be translated into the k-dimensional image feature vectors 136 using the CNN. The same CNN may be used to generate the textual feature vector 134 for the query 160. The k-dimensional feature vectors 132 may be vectors representable in a Euclidean space. The dimensions in the k-dimensional feature vectors 132 may represent variables determined by the CNN describing the images in the catalog 126 and describing text of the query 160. The k-dimensional feature vectors 132 are representable in the same multimodal space, and can be compared using a distance comparison in the multimodal space.

The images of the catalog 126, may be applied to the encoder 122, e.g., CNN-LSTM encoder. In an example, the CNN workflow for image feature extraction may comprise image preprocessing techniques for noise removal and contrast enhancement and feature extraction. In an example, the CNN-LSTM encoder may comprise stacked convolution and pooling layers. One or more layers of the CNN-LSTM encoder may work to build a feature space, and encode k-dimensional feature vectors 132. An initial layer may learn first order features, e.g. color, edges etc. A second layer may learn higher order features, e.g., features specific to the input dataset. In an example, the CNN-LSTM encoder may not have a fully connected layer for classification, e.g. a softmax layer. In an example, the encoder 122 without fully connected layers for classification, may enhance security, enable faster comparison and may require less storage space. The network of stacked convolution and pooling layers may be used for feature extraction. The CNN-LSTM encoder may use the weights extracted from at least one layer of the CNN-LSTM as a representation of an image of the catalog of images 126. In other words, features extracted from at least one layer of the CNN-LSTM may determine an image feature vector of the image feature vectors 136. In an example, the weights from a 4096-dimensional fully connected layer will result in a feature vector of 4096 features. In an example, the CNN-LSTM encoder may learn image-sentence relationships, where sentences are encoded using long short-term memory (LSTM) recurrent neural networks. The image features from the convolutional network may be projected into the multimodal space of the LSTM hidden states to extract additional textual feature vector 134. Since the same encoder 122, is used the image feature vectors 136 may be compared to the extracted textual feature vector 134 in the multimodal space 130.

In an example, the system 100 may be an embedded system in a printer. In another example the system 100 may be in a mobile device. In another example the system 100 may be in a desktop computer. In another example the system 100 may be in a server.

Referring to FIG. 2, encoder 122 may encode query 160 to produce the k-dimensional textual feature vector 134 representable in the multimodal space 130. In an example, the encoder 122 may be a convolution neural network-long short-term-memory encoder (CNN-LSTM). In another example, the encoder 122 may be TensorFlow® framework, CNN model, LSTM model, seq2seq (encoder-decoder model) etc. In another example, the encoder 122 may be a structure neutral language model (SC-NLM Encoder). In another example, the encoder 122 may be a combination of CNN-LSTM and SC-NLM encoders.

In an example, the query 160 may be a speech query describing an image to be searched. In an example, the query 160 may be represented as a vector of power spectral density coefficients of data. In an example, filters may be applied to the speech vector, such as accent, enunciation, tonality, pitch, inflection etc.

In an example, natural language processing (NLP) 212 may be applied to the query 160 to determine text for the query 160 that is applied as input to the encoder 122 to determine the textual feature vector 134. The NLP 212 derives meaning from human language. The query 160 may be provided in a human language, such as in the form of speech or text, and the NLP 212 derives meaning from the query 122. The NLP 212 may be provided from NLP libraries stored in the system 100. Examples of the NLP libraries may include Apache OpenNLP®, which is an open source machine learning toolkit that provides tokenizers, sentence segmentation, part-of-speech tagging, named entity extraction, chunking, parsing, coreference resolution, and more. Another example is the Natural Language Toolkit (NLTK), which is a Python® library that provides modules for processing text, classifying, tokenizing, stemming, tagging, parsing, and more. Another example is the Stanford NLP®, which is a suite of NLP tools that provide part-of-speech tagging, the named entity recognizer, coreference resolution system, sentiment analysis, and more.

For example, the query 160 may be natural language speech describing an image to be searched. The speech from the query 160 may be processed by the NLP 212 to obtain text describing the image to be searched. In another example, the query 160 may be natural language text describing an image to be searched, and the NLP 212 derives text describing the meaning of the natural language query. The query 160 may be represented as a word vectors.

In an example, the query 160 includes the natural language phrase

“Print me that photo, with the dog catching a ball” which is applied to the NLP 212. From that input phrase, the NLP 212 derives text, such as “Dog catching ball”. The text may be applied to the encoder 122 to determine the textual feature vector 134. In an example, the query 160 may not be processed by the NLP 212. For example, the query 160 may be a text query stating “Dog catching ball”.

The encoder 122 determines the k-dimensional feature vectors 132. For example, prior to encoding the text for the query 160, the encoder 122 may have previously encoded the images of the catalog 126 to determine the image feature vectors 136. Also, the encoder 122 determines the textual feature vector 134 for the query 160. The k-dimensional feature vectors 132 are represented in the multimodal space 130. The k-dimensional feature vectors 132 are compared in the multimodal space 130, e.g., based on cosine similarity, to identify closest k-dimensional feature vectors in the multimodal space. The image feature vector of image feature vectors 136 that is closest to the textual feature vector 134 represents the matching image 146. The index 124 may contain the image feature vectors 136 and an ID for each image. The index 124 is searched with the matching image feature vector to obtain the corresponding identifier (ID), such as ID 214. ID 214 may be used to retrieve the actual matching image 146 from the catalog 126. The matching image may include more than one image. In an example, catalog of images 126 is not stored on system 100. The system 100 may store the index 124 of image feature vectors 136 of the catalog 126 and delete any received catalog of images 126 after creating the index 124.

In an example, the query 160 may be an image or a combination of an image, speech, and/or text. For example, the system 100 may receive the query 160 stating “Find me a picture similar to the displayed photo.” The encoder 122 encodes both the image and text of the query to perform the matching.

In an example, the matching image 146 may be displayed on the system 100. In another example, the matching image 146 may be displayed on a printer. In another example, the matching image 146 may be displayed on a mobile device. In another example, the matching image 146 may be directly printed. In another example, the matching image 146 may not be displayed on the system 100. In another example, the displayed matching image 146 may include the top-n matching images, where n is a number greater than 1. In another example, the matching image 146 may be further filtered based on date of creation, based on features such as time of day, such as morning. In an example, time of day of an image may be determined by encoding time of day to the k-dimensional textual feature vector 136. The top-n images obtained by a previous search may be further processed to include or exclude images with “morning.”

FIGS. 3A, 3B and 3C depict examples of training the encoder 122. For example, the system 100 receives a training set comprises images and, for each image, a corresponding textual description describing the image. The training set may be applied to the encoder 122 (e.g., CNN-LSTM) to train the encoder. The encoder 122 may store data in one or more of the data storages 121 and 123 based on the training to process images and queries received subsequent to the training. The encoder 122 may create a joint embeddings 220, represented in the FIGS. 3A, 3B and 3C as 220a, 220b, 220c respectively.

FIG. 3A shows an image 310 and corresponding description 311 (“A row of classic cars”) from the training set. The encoder 122 extracts an image feature vector representable in the multimodal space 130 from the image 310. Similarly, the encoder 122 extracts a textual feature vector representable in the multimodal space 130 from the description 311.

The encoder 122 may create joint embeddings 220 from the textual feature vector and the image feature vector. By way of example, the encoder 122 is a CNN-LSTM encoder, which can create both textual and image feature vectors. The joint embeddings 220a may include proximity data between the feature vectors. The feature vectors which are proximate in the multimodal space 130 may share regularities captured in the joint embeddings 220. To further explain the regularities by way of example, a textual feature vector (‘man’) may represent linguistic regularities. A vector operation, vector(‘man’)−vector(‘king’)+vector(‘woman’) may produce vector(‘queen’). In another example, the vectors could be image and/or textual feature vectors. In another example, images of a red car and a blue car may be distal, when compared with distance between images of a red car and a pink car in the multimodal space 130. The regularities between the k-dimensional vectors 132 may be used to further enhance the results of queries. In an example, these regularities may be use to retrieve additional images when the results returned are less than a threshold. In an example, the threshold may be cosine similarity of less than 0.5. In another example, the threshold may be cosine similarity between 1 and 0.5. In another example, the threshold may be cosine similarity between 0 and 0.5.

In FIG. 3B, system 100 may process the k-dimensional textual feature vector 136 through a Structure- Content Neutral Language Model (SC-NLM) decoder 330 to obtain non-structured k-dimensional textual feature vectors representable in the multimodal space 130, which may then be stored by the encoder 122 in one or more data storages 121 and 122 to increase the accuracy of the encoder 122. An SC-NLM decoder 330 disentangles the structure of a sentence from its content. SC-NLM decoder 330 works by obtaining a plurality of proximate words and sentences to the image feature vector in the multimodal space of k-dimensions. A plurality of parts of speech sequences are generated based on the plurality of proximate words and sentences identified. Each parts of speech sequence is then scored based on how plausible a parts of speech sequence is and based on proximity to each of the plurality of part of speech sequences to the image feature vector used as the starting point. In another example, the starting point may be a textual feature vector representable in the multimodal space. In another example, the starting point may be a speech feature vector representable in the multimodal space. The SC-NLM decoder 330 may create additional joint embeddings 220c. In another example the SC-NLM decoder 220 may update existing joint embeddings 220c.

In FIG. 3C, system 100 may receive an audio description 312 of the image 310. The encoder 122 may use filtering and other layers on the audio to extract k-dimensional speech feature vectors representable in a multimodal space 130. An audio speech query may be treated as a vector of power spectral density coefficients of data 313. In an example, a speech query may be represented as k-dimensional vector 132. In another example, the audio description may be converted into textual description and then the encoder 122 may encode the textual description to the k-dimensional textual feature vector 134 representable in a multimodal space 130.

Encoder 122 may create at least one joint embedding 220b, which contain k-dimensional feature vectors 132 representable in the multimodal space 130. These joint embeddings 220 may include proximity data between the image feature vectors 136, proximity data between textual feature vectors 134, proximity data between speech feature vectors and proximity information between different kinds of feature vectors such as textual feature vectors, image feature vectors and speech feature vectors. The joint embeddings 220 with multiple feature vectors in multimodal space 130 may be used to increase the accuracy of the searches.

In other examples, systems shown in FIG. 3A, 3B, 3C may include other encoders or may have fewer encoders. In other examples, joint embeddings 220 may be stored on a server. In another example, joint embeddings 220 may be stored on a device connected to a network device. In another example, joint embeddings 220 may be stored on the system running the encoder 122. In an example, the joint embeddings 220 may be enhanced by continuous training. The query 160 provided by a user of the system 100, may be used to train the encoder 122 to produce more accurate results. In an example, the description provided by the user may be used to enhance results for that user, or for users from a particular geographical region or for users on a particular hardware. In an example, a printer model may contain idiosyncrasies such as a microphone which is more sensitive to certain frequencies. These idiosyncrasies may result in inaccurate speech to text conversions. The model may correct for users with the printer model, based on additional training. In another example, British and American users may use different words vacation vs holidays, apartment's vs flats, etc. In an example, the search results for each region may be modified.

In an example, the descriptions of the images produced by the systems in FIG. 3A, FIG. 3B, FIG. 3C are not stored on the system. In an example, k-dimensional vectors 132 may be stored on a system, without storing the catalog 126. This may be used to enhance system security and privacy. This may also require less space on embedded devices. In an example, the encoder 122, e.g. CNN-LSTM, may be encrypted. For example, an encryption scheme may be homomorphic encryption. In an example, the encoder 122 and data storage 121 and 123 are encrypted after training. In another example, the encoder is provided encrypted training set encrypted using a private key. Subsequent to training access is secure, and restricted to uses with access to the private key. In an example, the catalog 126 may be encrypted using the private key. In another example, the catalog 126 may be encrypted using a public key corresponding to the private key. In an example, the query 160 may return the ID 214, identifying the matching images of catalog 126. In another example, the encoder 122 may be trained using unencrypted data, and then the encoder 122, with data storage 121 and 123 may be encrypted using a private key. The encrypted encoder 122, with data storage 121 and 123, along with a public key corresponding to the private key may be used to apply the encoder 122 to a catalog 128. Subsequently, query 160 may return the ID 214, identifying the matching images of catalog 126. In an example, the query 160 may be encrypted using the private key. In another example, the query 160 may be encrypted using the public key.

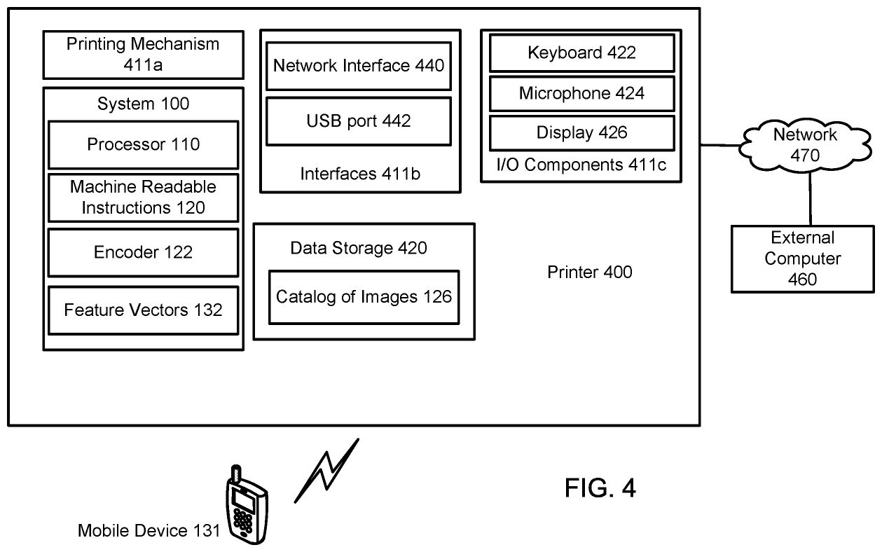

The system 100 may be in an electronic device. In an example, the electronic device may include a printer. FIG. 4 shows an example of a printer 400 including the system 100. The printer 400 may include components other shown. The printer 400 may include printing mechanism 411a, system 100, interfaces 411b, data storage 420, and Input/Output (I/O) components 411c. For example, the printing mechanism 411a may include at least one of an optical scanner, a motor interface, a printer microcontroller, a printhead microcontroller, or other components for printing and/or scanning. The printing mechanism 411a may print images or text received using at least one of an inkjet printing head, a laser toner fuser, a solid ink fuser and a thermal printing head.

The interfaces component 411b may include a Universal Serial Bus (USB) port 442, a network interface 440 or other interface components. The I/O components 411c may include a display 426, a microphone 424 and/or keyboard 422. The display 426 may be a touchscreen.

In an example, the system 100 may search for images in catalog 126 based a query 160 received via an I/O component, such as touch screen or keyboard 422. In another example, the system 100 may display a set of images based on a query received using the touch screen or keyboard 422. In an example the images may be displayed on display 426. In an example the images may be displayed as thumbnails. In an example, the images may be presented to the user for selection for printing. In an example, the images may be presented to the user for deletion from the catalog 126. In an example, the selected image may be printed using the printing mechanism 411a. In an example, more than one image may be printed by printing mechanism 411a, based on the matching. In another example, the system 100 may receive the query 160 using the microphone 424.

In another example, the system 100 may communicate with a mobile device 131 to receive the query 160. In another example, the system 100 may communicate with the mobile device 131 to transmit images for display on the mobile device 131 in response to a query 160. In another example, the printer 400 may communicate with an external computer 460 connected through network 470, via network interface 440. The catalog 126 may be stored on the external computer 460. In an example, k-dimensional feature vectors 132 may be stored on the external computer 460, and the catalog 126 may be stored elsewhere. In another example, the printer 400 may not include system 100 may be present on the external computer 460. The printer 400 may receive machine readable instructions update to allow communication between the external computer 460 to allow searching for images using query 160 and machine learning search system on external computer 460. In an example, the printer 400 may include a storage space to hold joint embeddings 220 representable in the multimodal space 130 on the printer 400. In an example, the printer 400 may include a data storage 420 storing the catalog of images 126. In an example, the printer 400 may store the joint embeddings 220 on the external computer 460. In an example, the catalog of images 126 may be stored on the external computer 460 instead of the printer 400.

The processor 110 may retrieve the matching image 146 from the external computer 460.

In an example, the display 426 may display matching images on the display 426 and receive a selection of a matching image for printing. In an example, the selection may be received via an I/O component. In another example, the selection may be received from the mobile device 131.

In an example, the printer 400 may use the index 124 which comprises k-dimensional image feature vectors and the identifier, or ID 214 which associates each image a k-dimensional image feature vector 136, to retrieve at least one matching image based on the ID 214.

In an example, the printer 400 may use a natural language processing, NLP 212 to determine a textual description of an image to be searched from the query 160. The query 160 may be a text or a speech. The textual description is determined by applying natural language processing, 212 to the speech or the text. In an example, the printer 400, may house the image search system 100, and may communicate using natural language processing, or NLP 212 to retrieve at least one image of the catalog 128 or at least one content related to the at least one image of the catalog 128 based on voice interaction.

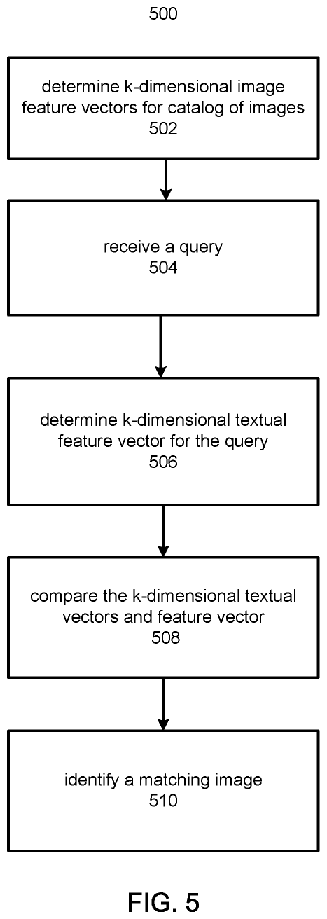

FIG. 5 illustrates a method 500 according to an example. The method 500 may be performed by the system 100 shown in FIG. 1. The method 500 may be performed by the processor 110 executing the machine readable instructions 120.

At 502, the image feature vectors 136 are determined by applying the images from the catalog 126 to the encoder 122. The catalog 126 may be stored locally or on a remote computer which may be connected to the system 100 via a network.

At 504, a query 160 may be received. In an example, the query 160 may be received through a network, from a device attached to the network. In another example, the query 160 may be received on the system through an input device.

At 506, the textual feature vector 134 of the query 160 may be determined based on the received query 160. For example, text for the query 160 is applied to the encoder 122 to determine the textual feature vector 134.

At 508, the textual feature vector 134 of the query 160 may be compared to the image feature vectors 136 of the images in the catalog 126 in the multimodal space to identify at least one of the image feature vectors 136 closest to the textual feature vector 134.

At 510, at least one matching image is determined from the image feature vectors closest to the textual feature vector 134.

While embodiments of the present disclosure have been described with reference to examples, those skilled in the art will be able to make various modifications to the described embodiments without departing from the scope of the claimed embodiments.

What is claimed is:

1. A machine learning image search system comprising:
a processor;
a memory to store machine readable instructions,
wherein the processor is to execute the machine readable instructions to:
encode each image in a catalog of images using a machine learning encoder to generate a k-dimensional image feature vector of each image representable in a multimodal space, where k is an integer greater than 1;
receive a query;
encode the query using the machine learning encoder to generate a k-dimensional textual feature vector representable in the multimodal space for the query;
compare the k-dimensional image feature vectors to the k-dimensional textual feature in the multimodal space; and
identify an image from the catalog of images matching the query based on the comparison.

2. The system of claim 1, wherein the processor is to execute the machine readable instructions to:
generate an index comprising the k-dimensional image feature vectors and an identifier of each image associated with the k-dimensional image feature vectors; and
in response to identifying the matching image, retrieve the matching image according to the identifier in the index for the matching image.

3. The system of claim 2, wherein the catalog of images are stored on a computer connected to the system via a network and to retrieve the matching, the processor is to retrieve the matching image according to the identifier from the computer connected to the system via the network.

4. The system of claim 1, wherein the received query comprises speech or text, and the processor is to execute the machine readable instructions to:
apply natural language processing to the speech or text to determine a textual description of an image to be searched; and
to encode the query, the processor is to encode the textual description to generate the k-dimensional textual feature vector.

5. The system of claim 1, wherein the processor is to execute the machine readable instructions to:
train the machine learning encoder, wherein the training comprises:
determine a training set of images with corresponding textual description for each image in the training set;
apply the training set of images to the machine learning encoder;
determine an image feature vector in the multimodal space for each image in the training set;
determine a textual feature vector in the multimodal space for each corresponding textual description; and
create a joint embedding of each image in the training set comprising the image feature vector and the textual feature vector for the image.

6. The system of claim 5, wherein the processor is to execute the machine readable instructions to:
apply the image feature vector of each image in the training set to a structure-content neural language model decoder to obtain an additional textual feature vector for each image; and
include the additional textual feature vector for each image in the joint embedding for the image.

7. The system of claim 1, wherein the system is an embedded system in a printer, a mobile device, a desktop computer or a server.

8. The system of claim 1, wherein k is a value resulting in each k-dimensional image feature vector occupying less storage space than the image corresponding to each k-dimensional image feature vector.

9. A printer comprising:
a processor;
a memory;
a printing mechanism,
wherein the processor is to:
determine a k-dimensional image feature vector for each image in a catalog of images based on applying each image to a machine learning encoder, wherein the k-dimensional image feature vectors are representable in a multimodal space;
receive a query;
determine a k-dimensional textual feature vector for the received query based on applying the received query to the machine learning encoder;
compare the k-dimensional textual feature vector to the k-dimensional image feature vectors in the multimodal space 130;
identify matching images from the comparison; and
print at least one of the matching images using the printing mechanism.

10. The printer of claim 9, further comprising:
a display, wherein the processor is to:
display the matching images on the display; and
receive a selection of the at least one of the matching images for printing.

11. The printer of claim 9, wherein the processor is to:
receive a selection of the at least one of the matching images for printing from an external device.

12. The printer of claim 9, wherein the catalog of images are stored on a computer connected to the printer via a network and to print at least one of the matching images, the processor is to retrieve the at least one of the matching images from the computer connected to the system via the network.

13. The printer of claim 9, wherein an index comprises the k-dimensional image feature vectors and an identifier of each image associated with the k-dimensional image feature vectors, and to retrieve the at least one of the matching images the processor is to identify the at least one of the matching images according to the identifier in the index for the at least one of the matching images.

14. The printer of claim 9, wherein the processor is to:
determine a textual description of an image to be searched from the query, wherein the received query comprises speech or text, and textual description is determined based on applying natural language processing to the speech or text.

15. A method comprising:
determining k-dimensional image feature vectors for stored images based on applying the stored images to a machine learning encoder, wherein the k-dimensional image feature vectors are representable in a multimodal space;
receiving a query;
determining a k-dimensional textual feature vector for the received query based on applying the received query to the machine learning encoder;
comparing the k-dimensional textual feature vector to the k-dimensional image feature vectors in the multimodal space to identify a k-dimensional image feature closest to the k-dimensional textual feature; and
identifying a matching image corresponding to the closest k-dimensional image feature.
